(19) United States
(12) Patent Application Publication
(10) Pub. No.: US 2019/0104402 A1
(43) Pub. Date: Apr. 4, 2019

(54) MANAGING ACCESS TO GROUP COMMUNICATION HISTORY FOR MULTIPLE SERVICES

(71) Applicant: MOTOROLA SOLUTIONS, INC, Chicago, IL (US)

(72) Inventors: MADHUSUDAN PAI, PALATINE, IL (US); VAIDYANATH CHANDRAMOWLEESWARAN, PALATINE, IL (US); RITESH DESAI, ALGONQUIN, IL (US); VIRAT G. PATEL, DES PLAINES, IL (US)

(21) Appl. No.: 15/723,988

(22) Filed: Oct. 3, 2017

(51) Int. Cl. H04W 8/18; H04W 4/10; H04L 12/58; H04L 29/08

(52) U.S. Cl. CPC H04W 8/186; H04L 67/22; H04L 51/16; H04W 4/10

(57) ABSTRACT

A method and console are provided that assign a user device access to a remote service, such as a talk group. The user device is provided access to communications history associated with the remote service. At some point access to the remote service for the user device is revoked, but access to the communications history associated with the remote service is not revoked at this time. At a later time, access to the communications history associated with the remote service from the user device is revoked.

### BACKGROUND OF THE INVENTION

There are times when a privileged user device, such as a console, desires to remotely assign a talk group to a user device. The talk group can be active or monitored by the user device. This talk group assignment is typically temporary and is assigned, for example, when a public safety officer arrives at an incident scene.

While assigned to the temporary talk group, the user device has access to the history and logs of that talk group. As used herein, the term “history” refers to a list of previous communication events on the group that includes multiple services for which the group is available, such as voice services and data services. As used herein, the term “logs” refers to metadata and content of previous communication events on the group, such as multiple services for which the group is available, for example voice services and data services. Once deassigned from that temporary talk group, the user device loses access to the history and logs associated with that talk group. This can be disadvantageous of the user device later wants to check the logs or history of that talkgroup but no longer has access to the logs and history.

Therefore a need exists for a way of temporarily providing access to a talk group for a user device while allowing the user device to have access to history and logs associated to the talk group after the user device has been deassigned from the temporary talk group.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 depicts a system diagram of a portion of a communication system in accordance with an exemplary embodiment of the present invention.

FIG. 2 depicts a call flow diagram in accordance with an exemplary embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

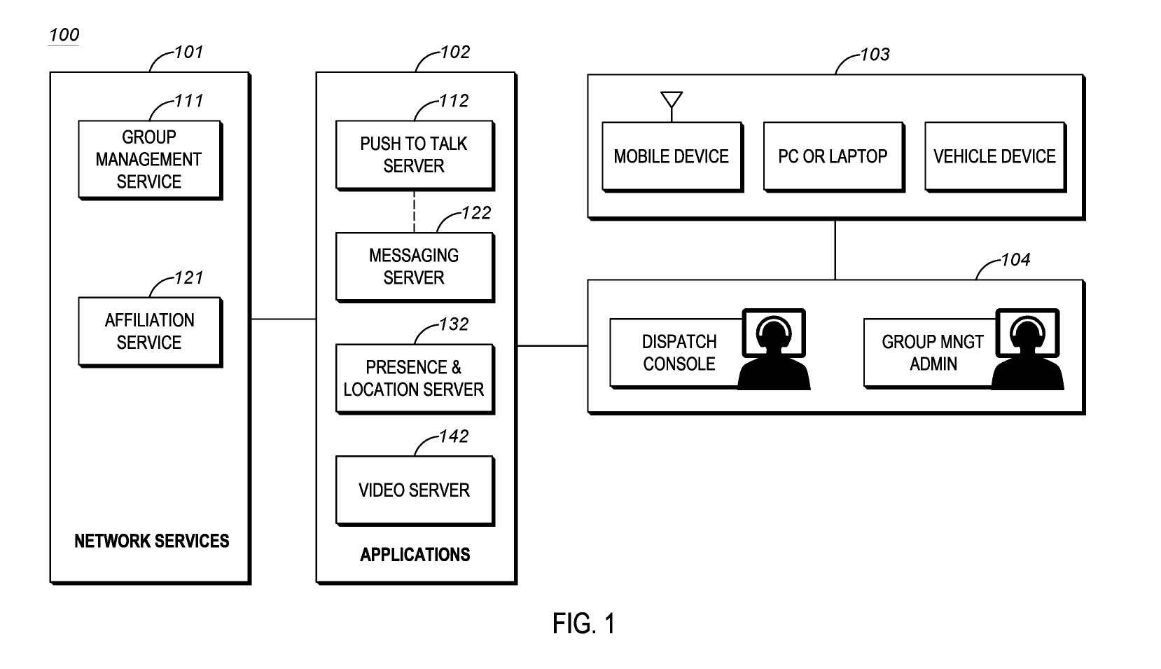

FIG. 1 depicts a system diagram of a portion of a communication system 100 in accordance with an exemplary embodiment of the present invention. Communication system 100 preferably provides voice services, which includes push to talk services, along with data services, such as messaging, mapping, presence, and location services. Communication system 100 comprises network services 101, network applications 102, user device 103, and privileged user devices 104.

Network services 101 preferably includes a group management service and an affiliation service, and can alternately includes other services. The group management service preferably manages the assignment of groups to users. The affiliation service preferably manages the set of users currently monitoring the groups in the system. For example, the group management service may make a group available to thousands of users, whereas the affiliation service may manage the hundred users currently affiliated to the group and interested in communication events on that group.

Network applications 102 preferably include voice applications and data applications. Voice applications include voice services and push to talk communications. Data applications includes, for example, video, messaging, mapping, and many other applications. In accordance with an exemplary embodiment, network applications 102 target communication events to users assigned the group or a subset of users affiliated to the group.

User devices 103 can send and receive data and voice communications to other user devices. In accordance with an exemplary embodiment, user devices receive group list and affiliation updates. User devices includes mobile handsets, fixed computing devices, and vehicle devices.

Privileged user devices 104 preferably control the users assignment to groups and users affiliated to groups. Privileged user devices can include, for example, dispatch console operators and contact/group management administrators.

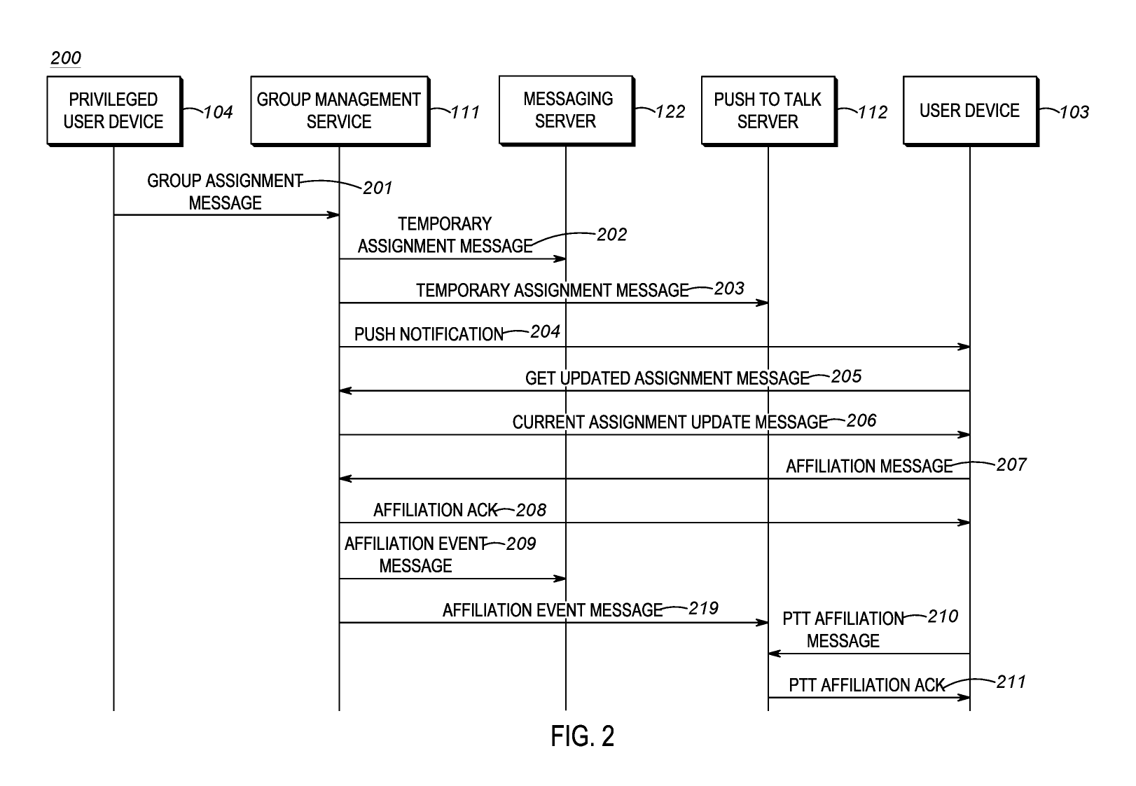

FIG. 2 depicts a call flow diagram 200 in accordance with an exemplary embodiment of the present invention. In this exemplary embodiment, a privileged user device, such as a console or Agency Contact/Group Administrator, controls the affiliation capabilities of a user of a user device with respect to talk group assignments.

In accordance with an exemplary embodiment, privileged user device 104 sends Group Assignment Message 201 to Group Management and Affiliation Service 111. Group Assignment Message 201 indicates that a user desires to use one or more services, such as Push To Talk or Messaging.

To begin the process, Group Management and Affiliation Service 111 sends Temporary Assignment Message 202 to Messaging Server 122. Group Management and Affiliation Service 111 also sends Temporary Assignment Message 203 to PTT Server 112.

Group Management and Affiliation Service 111 sends Push Notification 204 to user device 103, informing user device 103 of an update.

User device 103 sends Get Updated Assignment Message 205 to Group Management and Affiliation Service 111.

Group Management and Affiliation Service 111 sends Current Assignment Update Message 206 to user device 103.

User device 103 expresses interest to participate in communication events on the group by sending Affiliation Message 207 to Group Management and Affiliation Service 111.

Group Management and Affiliation Service 111 sends Affiliation Ack 208 to user device 103.

Group Management and Affiliation Service 111 sends Affiliation Event Message 209 to Messaging Server 122.

Group Management and Affiliation Service 111 sends Affiliation Event Message 219 to Push To Talk Server 112.

In accordance with an exemplary embodiment, user device 103 directly sends PTT Affiliation Message 210 to PTT Server 112.

PTT Server 112 sends PTT Affiliation Ack 211 to user device 103.

From this point onward, user device 103 is included in all group communications for the assigned talk group. User device 103 can access information associated with the talk group, such as the history of the talk group, logs of the talk group, etc. If the assignment is for a messaging service, user device 103 has access to previous messages in the messaging service. If the assignment is for a PTT service, user device 103 has access to voice logs for previous calls. If the assignment is for a video service, user device 103 has access to previously shared video URLs. The user of user device 103 can look at stored information related to the talk group, preferably even the history from the time before the user device temporarily joined the talk group. In an exemplary embodiment, the amount of information that a user of user device 103 can view going backward is unlimited. In a further exemplary embodiment, the amount of information that a user of user device 103 can view going backward is limited to a predetermined time period.

In accordance with an exemplary embodiment, access to the services may be updated at any time. In addition, at some point, the user's access to the history is removed from user device 103 by the privileged user device, such as the console. In accordance with an exemplary embodiment, access to the history of the talk group can be revoked at the same time that the user loses access to the associated talk group. In a further exemplary embodiment, access to the history can be revoked after a timer expires. In a further exemplary embodiment, access to the history can be revoked at a predetermined time in the future. In a further exemplary embodiment, access can be revoked at a time when the privileged user device makes a determination that the access should be revoked.

In accordance with an exemplary embodiment, the history is stored on user device 103. In a further exemplary embodiment, the history is stored for user device 103 on a network device. The history can be deleted from either location, either at the time of removal from the talk group, at a predetermined time, at the expiration of a timer, or upon a command from the privileged user device.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method comprising:
assigning a user device access to a remote service;
providing access to communications history associated with the remote service to the user device;
revoking access to the remote service for the user device, wherein the revoking of access to the remote service does not revoke access from the user device to the communications history associated with the remote service; and
at a later time, revoking access to the communications history associated with the remote service from the user device.

2. The method of claim 1, the method further comprising the step of storing the communications history associated with the remote service at the user device.

3. The method of claim 2, the method further comprising the step of deleting the communications history from the user device.

4. The method of claim 3, wherein the step of deleting the communications history from the user device comprises deleting the communications history from the user device after a predetermined time period.

5. The method of claim 3, wherein the step of deleting the communications history from the user device comprises deleting the communications history from the user device at a predetermined time.

6. The method of claim 1, the method further comprising the step of storing the communications history associated with the remote service at a network device.

7. The method of claim 6, the method further comprising the step of deleting the communications history from the network device after a predetermined time period.

8. The method of claim 6, the method further comprising the step of deleting the communications history from the network device at a predetermined time.

9. The method of claim 1, wherein additional events are added to the communications history after the revoking of access to the remote service for the user device, and wherein the user device has access to the additional events after the step of revoking access to the remote service for the user device and prior to the revoking of access to the communications history.

10. The method of claim 1, wherein the step of providing access to communications history associated with the remote service to the user device happens automatically upon the step of assigning the user device access to the remote service.

11. A privileged user device comprising a processor configured to:
assign a user device access to a remote service;
provide access to communications history associated with the remote service to the user device;
revoke access to the remote service for the user device, wherein the revoking of access to the remote service does not revoke access from the user device to the communications history associated with the remote service; and
at a later time, revoke access to the communications history associated with the remote service from the user device.

12. The privileged user device of claim 11, wherein the processor is further configured to store the communications history associated with the remote service at a network device.

13. The privileged user device of claim 12, wherein the processor is further configured to delete the communications history from the network device after a predetermined time period.

14. The privileged user device of claim 12, wherein the processor is further configured to delete the communications history from the network device at a predetermined time.

15. The privileged user device of claim 11, wherein additional events are added to the communications history after the revoking of access to the remote service for the user device, and wherein the processor is configured to provide access for the user device to the additional events after the step of revoking access to the remote service for the user device and prior to the revoking of access to the communications history.

16. The privileged user device of claim 11, wherein the step of providing access to communications history associated with the remote service to the user device happens automatically upon the step of assigning the user device access to the remote service.
